(19) United States
(12) Patent Application Publication
(10) Pub. No.: US 2026/0365170 A1
(43) Pub. Date: Nov. 19, 2026

(54) REGENERATIVE BRAKING APPARATUS FOR VEHICLE AND CONTROL METHOD THEREFOR

(71) Applicant: HYUNDAI MOBIS CO., LTD., Seoul (KR)

(72) Inventors: Deuk Won YOON, Yongin-si (KR); Jun Han LEE, Yongin-si (KR)

(73) Assignee: HYUNDAI MOBIS CO., LTD., Seoul (KR)

(21) Appl. No.: 19/432,661

(22) Filed: Dec. 24, 2025

(30) Foreign Application Priority Data
Mar. 13, 2025 (KR) 10-2025-0032536

(51) Int. Cl. B60W 30/18; B60W 10/188; B60W 10/192; B60W 50/029

(52) U.S. Cl. CPC B60W 30/18127; B60W 10/188; B60W 10/192; B60W 50/029; B60W 2050/0292; B60W 2552/40; B60W 2710/18

(57) ABSTRACT

The present disclosure relates to a regenerative braking apparatus for a vehicle and a control method therefor. An embodiment of the present disclosure provides a control method for regenerative braking of a vehicle configured to generate hydraulic braking force, the control method comprising: determining any one of a front wheel brake fluid leak failure, a rear wheel brake fluid leak failure, and a hydraulic actuator failure of the vehicle; determining one or more wheels capable of generating hydraulic braking force among front wheels, rear wheels or both based on driving wheels of the vehicle; and generating regenerative braking force for the front wheels, the rear wheels or both based on a failure situation of the vehicle and the driving wheels.

### CROSS-REFERENCE TO RELATED APPLICATION

This application claims the benefit of and priority to Korean Patent Application No. 10-2025-0032536, filed on March 13, 2025, the entire disclosure(s) of which is hereby incorporated herein by reference in its entirety.

### TECHNICAL FIELD

The present disclosure relates to a regenerative braking apparatus for a vehicle and a control method therefor.

### BACKGROUND

The content to be described below merely provides background information related to the present embodiment and does not constitute related art.

In an electronic stability control (ESC) integrated regenerative braking system, when a brake fluid leak failure occurs in a vehicle, braking pressure is generated by using a normal part or whole of a hydraulic pressure circuit of front and rear wheels, and regenerative braking is assisted by a drive motor of a shaft at which the brake fluid leak has occurred, thereby securing a certain level of deceleration.

When an actuator that generates hydraulic pressure fails, a regenerative braking system according to the related art cannot generate the hydraulic pressure through electrical control, and therefore, the regenerative braking system is switched to a mechanical scheme to generate the hydraulic pressure for front and rear wheels using driver's brake pedal pressure. Further, a scheme for securing deceleration by assisting regenerative braking of the drive motor is used.

The related art proposes a method of closing a hydraulic control valve to maintain braking force applied before a hydraulic actuator fails, when the hydraulic actuator fails. This is designed to secure the braking force even in an emergency situation.

However, in the regenerative braking system according to the related art, when a brake fluid leak failure occurs in a front or rear wheel, regenerative braking is performed in a limited manner based on a vehicle's drive type, such as front-wheel drive, rear-wheel drive, or four-wheel drive.

Further, the regenerative braking system according to the related art has a problem in that deceleration performance is degraded when the vehicle is suddenly stopped because regenerative braking is released at once during ABS control. In particular, there is a problem that, when a hydraulic actuator that generates hydraulic braking force fails, an ABS function does not operate, and therefore, wheel slip cannot be controlled even when the wheel slip occurs in a vehicle. This may reduce the braking stability of the vehicle and may be likely to cause a dangerous situation on a low-friction road.

### SUMMARY

Therefore, the present disclosure is intended to solve these problems, and a main object of the present disclosure is to improve braking stability in various vehicle failure situations using regenerative braking active control.

Another main object of the present disclosure is to increase a maximum deceleration reaching speed of a vehicle to improve braking responsiveness and robustness against a wheel slip situation.

The object of the present invention is not limited to the above-described object, and other objects that are not mentioned will be clearly understood by those skilled in the art from the description below.

An embodiment of the present disclosure provides a control method for regenerative braking of a vehicle configured to generate hydraulic braking force, the control method comprising: determining any one of a front wheel brake fluid leak failure, a rear wheel brake fluid leak failure, and a hydraulic actuator failure of the vehicle; determining one or more wheels capable of generating hydraulic braking force among front wheels, rear wheels or both based on driving wheels of the vehicle; and generating regenerative braking force for the front wheels, the rear wheels or both based on a failure situation of the vehicle and the driving wheels.

An embodiment of the present disclosure provides a regenerative braking apparatus for a vehicle that generates hydraulic braking force, the regenerative braking apparatus comprising: a sensor unit configured to detect any one of a front wheel brake fluid leak failure, a rear wheel brake fluid leak failure, and a hydraulic actuator failure of the vehicle; a processor configured to determine a failure situation of any one of the front wheel brake fluid leak failure, the rear wheel brake fluid leak failure, and the hydraulic actuator failure, and determine braking force required for the vehicle based on driving wheels of the vehicle; and a regenerative braking actuator configured to receive a braking command from the processor and generate hydraulic braking force, regenerative braking force or both in some or all of the wheels of the vehicle.

In the regenerative braking apparatus for a vehicle and the control method therefor according to an aspect, it is possible to improve braking stability in various failure situations of the vehicle by using regenerative braking active control.

In the regenerative braking apparatus for a vehicle and the control method therefor according to an aspect, it is possible to increase a maximum deceleration reaching speed of the vehicle to improve braking responsiveness and robustness against a wheel slip situation.

### BRIEF DESCRIPTION OF THE DRAWINGS

FIG. 1 is a block diagram illustrating a configuration of a regenerative braking apparatus for a vehicle according to the present disclosure.

FIG. 2 is a schematic diagram illustrating the regenerative braking apparatus for a vehicle according to the embodiment of the present disclosure.

FIG. 3 is a diagram illustrating a case in which a front wheel brake fluid leak failure occurs in the regenerative braking apparatus for a vehicle according to the embodiment of the present disclosure.

FIG. 4 is a graph showing a regenerative braking deceleration of a front wheel based on regenerative braking of the front wheels when a front wheel brake fluid leak failure occurs in a front-wheel drive or four-wheel drive type vehicle according to an embodiment of the present disclosure.

FIG. 5 is a graph showing a regenerative braking deceleration of a rear wheel based on regenerative braking of the rear wheels when a front wheel brake fluid leak failure occurs in a rear-wheel drive type vehicle according to an embodiment of the present disclosure.

FIG. 6 is a diagram illustrating a case in which a rear wheel brake fluid leak failure occurs in the regenerative braking apparatus for a vehicle according to the embodiment of the present disclosure.

FIG. 7 is a graph showing a regenerative braking deceleration of a front wheel based on regenerative braking of the front wheels when a rear wheel brake fluid leak failure occurs in a front-wheel drive type vehicle according to an embodiment of the present disclosure.

FIG. 8 is a graph showing a regenerative braking deceleration of a front wheel based on regenerative braking of the front wheels when a rear wheel brake fluid leak failure occurs in a rear-wheel drive or four-wheel drive type vehicle according to an embodiment of the present disclosure.

FIG. 9 is a diagram illustrating a case in which a failure occurs in a hydraulic actuator of the regenerative braking apparatus for a vehicle according to an embodiment of the present disclosure.

FIG. 10 is a graph showing a regenerative braking deceleration of the vehicle based on the regenerative braking of the front wheels when a hydraulic actuator fails in the front-wheel drive type vehicle according to an embodiment of the present disclosure.

FIG. 11 is a graph showing a regenerative braking deceleration of the vehicle based on the regenerative braking of the rear wheels when a hydraulic actuator fails in the rear-wheel drive type vehicle according to an embodiment of the present disclosure.

FIG. 12 is a graph showing a regenerative braking deceleration of the vehicle based on the regenerative braking of the front and rear wheels when a hydraulic actuator fails while the four-wheel drive type vehicle is driving on a high-friction road surface according to an embodiment of the present disclosure.

FIG. 13 is a graph showing a regenerative braking deceleration of a vehicle based on regenerative braking of front and rear wheels when a hydraulic actuator fails while a four-wheel drive type vehicle is driving on a low-friction road surface according to an embodiment of the present disclosure.

FIG. 14 is a flowchart showing a control method for regenerative braking of a vehicle according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

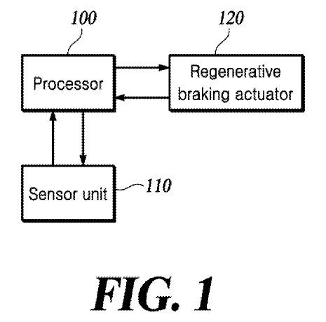

FIG. 1 is a block diagram illustrating a configuration of a regenerative braking apparatus for a vehicle according to the present disclosure.

Referring to FIG. 1, the regenerative braking apparatus for a vehicle according to the present disclosure includes some or all of a processor 100, a sensor unit 110, and a regenerative braking actuator 120.

The processor 100 according to the present disclosure calculates a braking torque required for wheel slip control when wheel slip occurs in the vehicle. The processor 100 according to the present disclosure determines a regenerative braking amount that decreases when regenerative braking force is generated, based on a torque required for regenerative braking slip control. The processor 100 transmits the determined regenerative braking amount to the regenerative braking actuator 120. The regenerative braking actuator 120 generates a regenerative braking force required for the vehicle based on a regenerative braking command received from the processor 100.

The processor 100 according to the present disclosure may perform regenerative braking active control even when a failure or abnormality occurs in any one of braking apparatuses of the vehicle.

For example, when wheel slip occurs in the vehicle and ABS control is performed, the processor 100 may generate regenerative braking force together with friction braking force for the front and rear wheels to improve the braking stability of the vehicle. In particular, even when the hydraulic actuator that generates a hydraulic braking force fails, the processor 100 may generate regenerative braking force to perform the regenerative braking slip control of the vehicle.

The sensor unit 110 according to the present disclosure may include a wheel speed sensor (not shown). The processor 100 may perform wheel slip control or calculate a deceleration required for the vehicle, based on a measured wheel speed value of each wheel from the sensor unit 110. Further, the processor 100 may calculate a regenerative braking amount required for the front or rear wheels based on the wheel speed value.

The regenerative braking actuator 120 according to the present disclosure may generate the regenerative braking force based on one of a single motor, a dual motor, and an in-wheel motor based on a drive type.

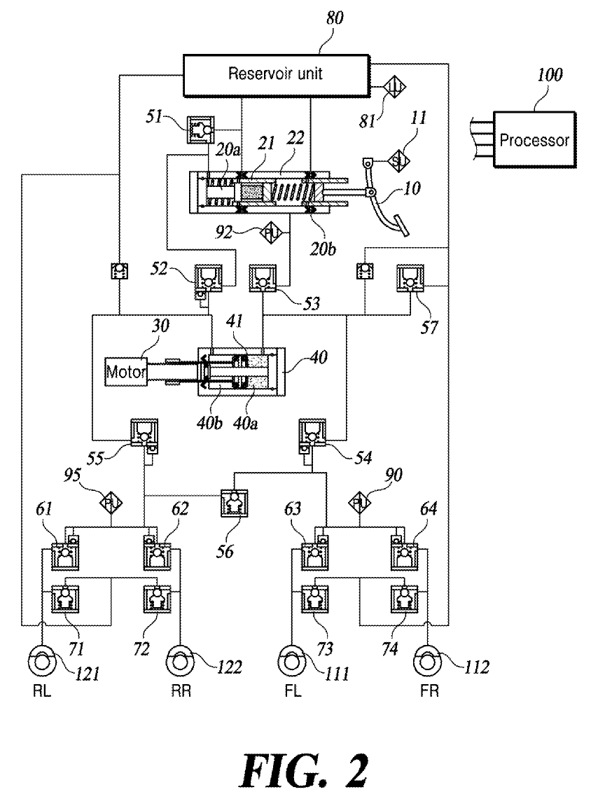

FIG. 2 is a diagram schematically illustrating the regenerative braking apparatus for a vehicle according to the embodiment of the present disclosure.

Referring to FIGS. 1 and 2, a control device of a vehicle according to the present embodiment includes a reservoir unit 80, a pedal cylinder unit 20, a motor 30, a master cylinder unit 40, wheel cylinders 111, 112, 121, and 122, hydraulic control valves 51, 52, 53, 54, 55, 56, and 57, and a processor 100.

The reservoir unit 80 is coupled to an upper portion of the pedal cylinder unit 20 to store brake oil. The reservoir unit 80 may include a reservoir fluid level sensor 81.

The pedal cylinder unit 20 generates hydraulic pressure when the brake pedal 10 is pressed. The pedal cylinder unit 20 includes a pedal simulator 21 and a pedal cylinder 22, and may include two chambers 20a and 20b, that is, a first chamber 20a and a second chamber 20b.

When a driver's pedal force is applied to the brake pedal 10, the hydraulic pressure is generated by the pedal cylinder 22. The generated hydraulic pressure is supplied to a piston of the pedal simulator 21, and an elastic body of the pedal simulator 21 is pressed. Pedal feel of the driver may be implemented by reaction force of the pressed elastic body.

The hydraulic actuator according to the present disclosure includes the motor 30 and the master cylinder unit 40.

The motor 30 is operated by an electrical signal that is output in response to a displacement of the brake pedal 10.

The processor 100 may receive a rotation detection signal of the brake pedal 10 and control driving of the motor 30.

The master cylinder unit 40 generates hydraulic pressure based on the driving of the motor 30. Using the generated hydraulic pressure, the master cylinder unit 40 supplies the hydraulic pressure to a plurality of wheel cylinders 111, 112, 121, and 122 that perform braking of respective wheels RR, RL, FR, and FL. Here, the processor 100 may include an electronic control unit (ECU).

When the driver steps on the brake pedal 10, a pedal stroke sensor 11 detects a stroke of the brake pedal 10 and transmits a detection signal to the processor 100. Based on the pedal stroke or displacement of the brake pedal 10 detected by the pedal stroke sensor 11, the processor 100 controls the motor 30 so that the hydraulic pressure generated from the master cylinder unit 40 is controlled. When the brake pedal 10 is pressed, the motor 30 may generate braking hydraulic pressure based on signals output from the pedal stroke sensor 11 and a pedal cylinder pressure sensor 92.

The master cylinder unit 40 includes a master piston 41 and may include two chambers 40a and 40b, that is, a third chamber 40a and a fourth chamber 40b.

The wheel cylinders 111, 112, 121, and 122 include a first wheel cylinder 111, a second wheel cylinder 112, a third wheel cylinder 121, and a fourth wheel cylinder 122.

The first wheel cylinder 111 brakes a front left wheel FL of the vehicle. The second wheel cylinder 112 brakes a front right wheel FR of the vehicle. The third wheel cylinder 121 brakes a rear left wheel RL of the vehicle. The fourth wheel cylinder 122 brakes a rear right wheel RR of the vehicle. The first wheel cylinder 111 and the second wheel cylinder 112 may be front wheel cylinders 111 and 112. The third wheel cylinder 121 and the fourth wheel cylinder 122 may be rear wheel cylinders 121 and 122.

Inlet valves 61, 62, 63, and 64 are provided to control the brake oil that is supplied to the respective wheel cylinders 111, 11 2, 121, and 122. Outlet valves 71, 72, 73, and 74 for controlling the brake oil discharged from the respective wheel cylinders 111, 112, 121, and 122 are provided in hydraulic passages between the respective wheel cylinders 111, 112, 121, and 122 and the reservoir unit 80.

The hydraulic control valves 51, 52, 53, 54, 55, 56, and 57 are provided in the hydraulic passages and are opened and closed under the control of the processor 100. The hydraulic control valves 51, 52, 53, 54, 55, 56, and 57 may include first to seventh hydraulic control valves. The first hydraulic control valve 51 is provided in a passage connecting the reservoir unit 80 and the first chamber 20a of the pedal cylinder unit 20. The second hydraulic control valve 52 is provided in a passage connecting the first chamber 20a of the pedal cylinder unit 20 and the fourth chamber 40b of the master cylinder unit 40. The third hydraulic control valve 53 is provided in a passage connecting the second chamber 20b of the pedal cylinder unit 20 and the third chamber 40a of the master cylinder unit 40. The fourth hydraulic control valve 54 is provided in a passage connecting the third chamber 40a of the master cylinder unit 40 and the wheel cylinder. The fifth hydraulic control valve 55 is provided in a passage connecting the fourth chamber 40b of the master cylinder unit 40 and the wheel cylinder. The sixth hydraulic control valve 56 (or split cutoff valve) is provided in a passage connecting the fourth hydraulic control valve 54 and the wheel cylinders 121 and 122, and a passage connecting the fifth hydraulic control valve 55 and the wheel cylinders 111 and 112. Here, the passage connecting the fourth hydraulic control valve 54 and the wheel cylinders 121 and 122 is connected to the fourth chamber 40b of the master cylinder unit 40 to transmit hydraulic pressure to the third and fourth wheel cylinders 121 and 122 which are respectively mounted on the two rear wheels RL and RR. Further, the passage connecting the fourth hydraulic control valve 54 and the wheel cylinders 121 and 122 may include a second pressure sensor 95 that measures the hydraulic pressure. Here, the second pressure sensor 95 may be omitted to reduce cost.

The passage connecting the fifth hydraulic control valve 55 and the wheel cylinders 111 and 112 is connected to the third chamber 40a of the master cylinder unit 40 to transmit hydraulic pressure to the first and second wheel cylinders 111 and 112 which are respectively mounted on the two front wheels FL and FR. The passage connecting the fifth hydraulic control valve 55 and the wheel cylinder may include a first pressure sensor 90 that measures the hydraulic pressure. The first to seventh hydraulic control valves 51, 52, 53, 54, 55, 56 and 57 may be normally operating valves or may be solenoid valves that are controlled by the processor 100. Further, the sixth hydraulic control valve 56 (or split cutoff valve) may be a line split valve.

The seventh hydraulic control valve 57 may be disposed between the reservoir unit 80 and the fourth hydraulic control valve 54.

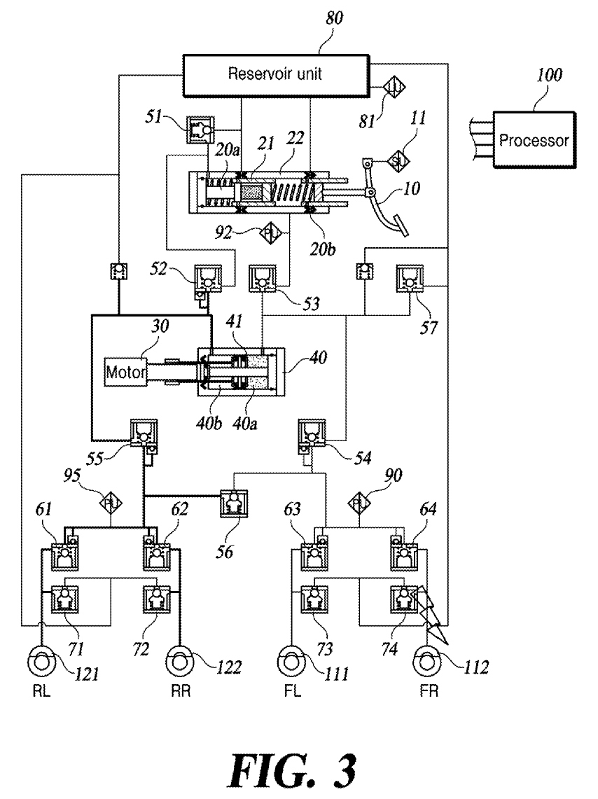

FIG. 3 is a diagram illustrating a case in which a front wheel brake fluid leak failure occurs in the regenerative braking apparatus for a vehicle according to the embodiment of the present disclosure.

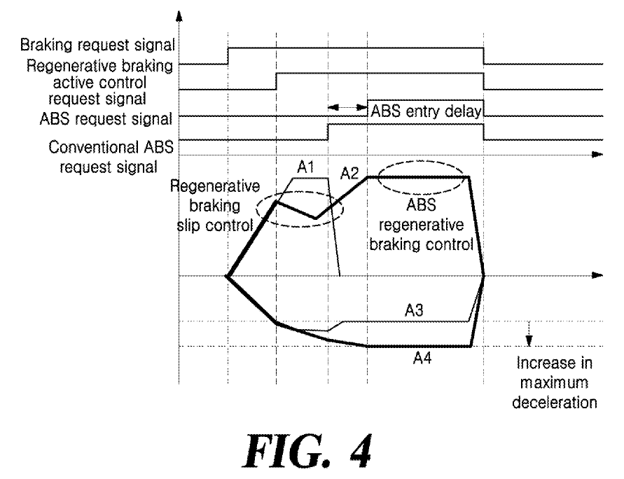

FIG. 4 is a graph showing a regenerative braking deceleration of a front wheel based on regenerative braking of the front wheel when the front wheel brake fluid leak failure occurs in a front-wheel drive or four-wheel drive type vehicle according to an embodiment of the present disclosure.

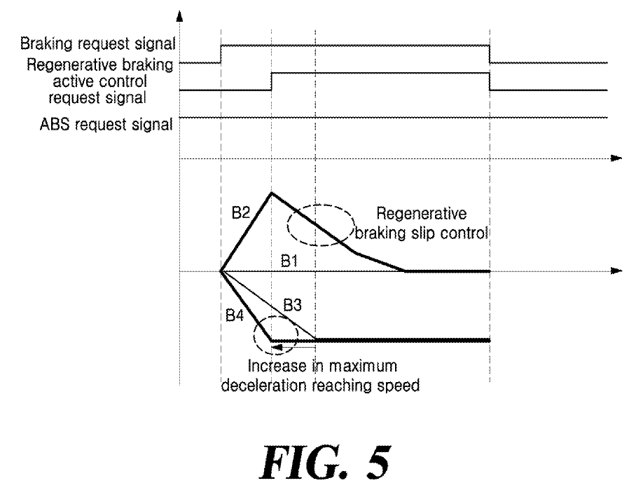

FIG. 5 is a graph showing a regenerative braking deceleration of a rear wheel based on regenerative braking of the rear wheel when a front wheel brake fluid leak failure occurs in a rear-wheel drive type vehicle according to an embodiment of the present disclosure.

Referring to FIGS. 1, 3, and 5, when a brake fluid leak failure occurs in a front wheel circuit, the vehicle cannot generate hydraulic braking force for front wheels. In this case, the processor 100 generates deceleration by using the hydraulic braking force for the rear wheels and regenerative braking assistance. Here, the regenerative braking force may be generated based on driving wheels of the vehicle. The vehicle may be one of front-wheel drive (FWD), rear-wheel drive (RWD), and four-wheel drive (4WD) based on the driving wheels.

In the present invention, the front wheels FL and FR include the front left wheel FL and the front right wheel FR. Further, the rear wheels RL and RR include the rear left wheel RL and the rear right wheel RR.

### Front wheel circuit failure/front-wheel drive or four-wheel drive

In a front-wheel drive (FWD) vehicle, when the brake fluid leak failure occurs in the front wheel circuit, the front wheels cannot generate hydraulic braking force, while the rear wheels can generate the hydraulic braking force.

In the front-wheel drive (FWD) vehicle, when the brake fluid leak failure occurs in the front wheel circuit,, the processor 100 performs backup braking of the vehicle using regenerative braking force for the front wheels and hydraulic braking force for rear wheels.

In a four-wheel drive (4WD) vehicle, when the brake fluid leak failure occurs in the front wheel circuit, the processor 100 performs the backup braking of the vehicle using the regenerative braking force for the front wheel, the hydraulic braking force for rear wheels, and regenerative braking force for the rear wheel.

In the front-wheel drive (FWD) or four-wheel drive (4WD) vehicle, when the brake fluid leak failure occurs in the front wheel circuit, the processor 100 generates the regenerative braking force for the front wheels to perform the backup braking of the vehicle. In this case, the processor 100 generates hydraulic braking force for the rear wheels using the second hydraulic control valve 52 and generates braking force together with the regenerative braking of the front wheels. Here, the front wheel circuit includes components that generate the hydraulic braking force for the front wheel. For example, the front wheel circuit may include a front wheel hydraulic brake device, a front wheel hydraulic line, and valves disposed in the front wheel hydraulic line.

Referring to a regenerative braking amount A2 of the front wheel and a corresponding deceleration A4 according to the present disclosure, when the brake fluid leak failure occurs in the front wheel circuit of the front-wheel drive (FWD) or four-wheel drive (4WD) vehicle, the processor 100 generates a braking request signal if a user's braking intention is delivered to the brake pedal 10.

Based on the generated braking request signal, the regenerative braking actuator 120 disposed on the front wheel increases the regenerative braking force. When the regenerative braking force for the front wheel increases, the processor 100 generates a regenerative braking active control request signal to perform regenerative braking slip control on the front wheel in order to prevent wheel slip of the front wheel due to generation of excessive regenerative braking force. Here, the regenerative braking slip control is to decrease the regenerative braking force by a certain amount, thereby preventing the front wheel from slipping due to the regenerative braking.

After the regenerative braking slip control of the front wheel, the processor 100 increases the regenerative braking force and maintains a constant regenerative braking amount based on an ABS request signal.

The regenerative braking amount A2 of the front wheel according to the present disclosure may allow the braking of the vehicle to be stably controlled through the regenerative braking slip control, compared to a front wheel regenerative braking amount A1 according to the related art. Further, the front wheel deceleration A4 according to the present disclosure may allow a maximum deceleration to increase through regenerative braking control based on the ABS request signal, compared to a front wheel deceleration A3 according to the related art.

### Front wheel circuit failure/rear-wheel drive

When the brake fluid leak failure occurs in a front wheel circuit of a rear-wheel drive (RWD) vehicle, the front wheels cannot generate hydraulic braking force, while the rear wheels can generate the hydraulic braking force.

The processor 100 according to the present disclosure may generate the hydraulic braking force for the rear wheels and the regenerative braking force for the rear wheels to improve deceleration responsiveness of the rear wheel, compared to the same pedal force when the brake fluid leak failure occurs in the front wheel circuit of the rear-wheel drive (RWD) vehicle.

Referring to a regenerative braking amount B2 of the front wheel and a corresponding deceleration B4 according to the present disclosure, when the brake fluid leak failure occurs in the front wheel circuit of the rear-wheel drive (RWD) vehicle, the processor 100 generates a braking request signal if a user's braking intention is delivered to the brake pedal 10.

Based on the generated braking request signal, the regenerative braking actuator 120 disposed on the rear wheel increases the regenerative braking force for the rear wheel. When the regenerative braking force for the rear wheel increases, the processor 100 generates the regenerative braking active control request signal to perform regenerative braking slip control on the rear wheel in order to prevent the rear wheel from slipping due to the generation of the excessive regenerative braking force. Here, the regenerative braking slip control is to temporarily decrease the regenerative braking force by a certain amount, thereby preventing the rear wheel from slipping due to regenerative braking.

The rear wheel regenerative braking amount B2 according to the present disclosure may allow a behavior of the vehicle to be stably controlled through regenerative braking slip control, compared to a rear wheel regenerative braking amount B1 according to the related art. Further, the rear wheel deceleration B4 according to the present disclosure may allow a time to reach the maximum deceleration to be shortened through the regenerative braking active control, compared to a rear wheel deceleration B3 according to the related art. Here, the shortening of the time to reach the maximum deceleration indicates reducing a braking distance of the vehicle, thereby increasing braking performance.

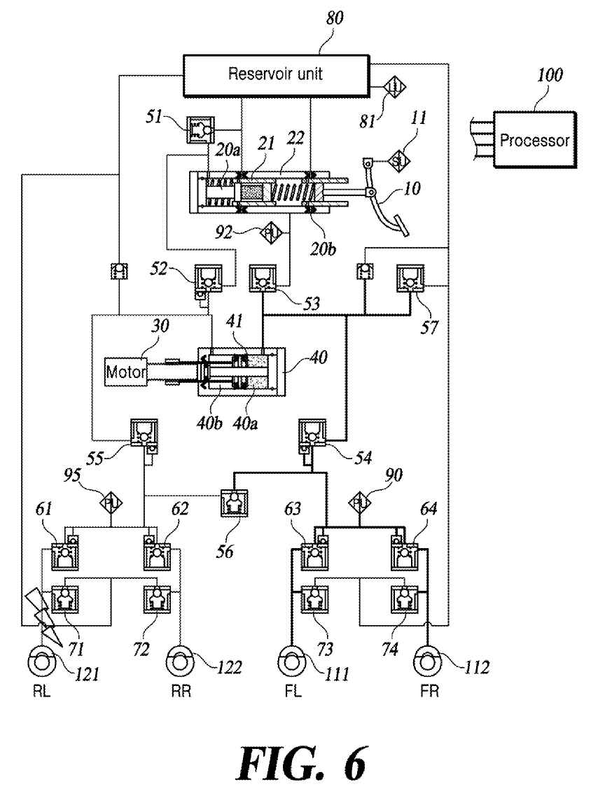

FIG. 6 is a diagram illustrating a case in which a rear wheel brake fluid leak failure occurs in the regenerative braking apparatus for a vehicle according to the embodiment of the present disclosure.

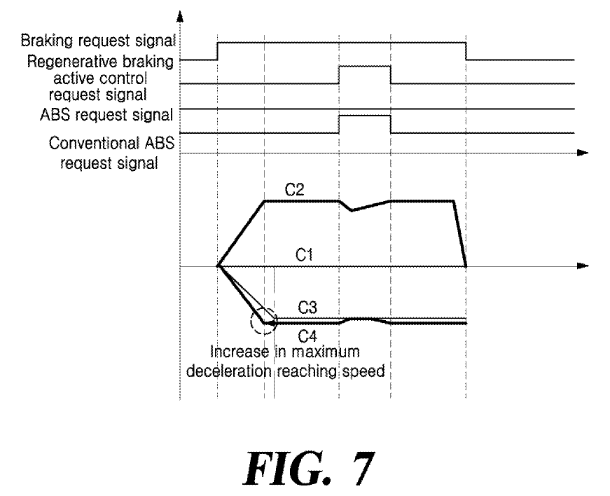

FIG. 7 is a graph showing a regenerative braking deceleration of a front wheel based on regenerative braking of the front wheel when a rear wheel brake fluid leak failure occurs in a front-wheel drive type vehicle according to an embodiment of the present disclosure.

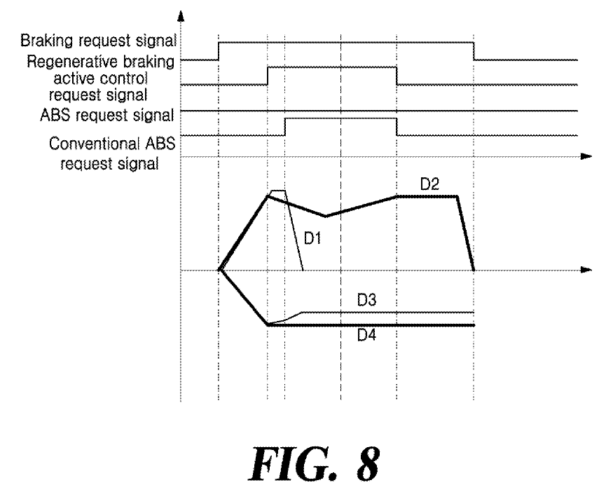

FIG. 8 is a graph showing a regenerative braking deceleration of a front wheel based on regenerative braking of the front wheel when a rear wheel brake fluid leak failure occurs in a rear-wheel drive or four-wheel drive type vehicle according to an embodiment of the present disclosure.

Referring to FIGS. 1 and 6-8, when the brake fluid leak failure occurs in the rear wheel circuit, the vehicle cannot generate hydraulic braking force for rear wheels. In this case, the processor 100 generates the hydraulic braking force and the regenerative braking force for the front wheels to generate the deceleration of the vehicle. Here, the processor 100 may generate the regenerative braking force based on the driving wheels of the vehicle.

### Rear wheel circuit failure/front-wheel drive

In the front-wheel drive (FWD) vehicle, when the brake fluid leak failure occurs in the rear wheel circuit, the rear wheel cannot generate the hydraulic braking force, while the front wheel can generate the hydraulic braking force.

In the front-wheel drive (FWD) vehicle, when the brake fluid leak failure occurs in the rear wheel circuit, the processor 100 generates the regenerative braking force for the front wheels to perform the backup braking of the vehicle. Here, the rear wheel circuit includes components that generate the hydraulic braking force in the rear wheel. For example, a rear wheel hydraulic braking apparatus and the rear wheel circuit may include rear wheel hydraulic lines and valves disposed in the rear wheel hydraulic lines.

The processor 100 according to the present disclosure may generate the regenerative braking force for the front wheels together with the hydraulic braking force for the front wheels to improve deceleration responsiveness of the front wheel, compared to the same pedal force.

Referring to a regenerative braking amount C2 of the front wheel and a corresponding deceleration C4 according to the present disclosure, when the brake fluid leak failure occurs in the rear wheel circuit in the front-wheel drive (FWD) vehicle, the processor 100 generates a braking request signal if a user's braking intention is delivered to the brake pedal 10.

Based on the generated braking request signal, the regenerative braking actuator 120 disposed on the front wheel increases the regenerative braking force. When the regenerative braking force for the front wheel increases, the processor 100 generates the regenerative braking active control request signal to perform regenerative braking slip control on the front wheel in order to prevent the rear wheel from slipping due to the generation of the excessive regenerative braking force. Here, the regenerative braking slip control can prevent the front wheel from slipping due to the regenerative braking by reducing the regenerative braking force for the front wheels by a certain amount.

The front wheel regenerative braking amount C2 according to the present disclosure may allow the behavior of the vehicle to be stably controlled through regenerative braking slip control, compared to the front wheel regenerative braking amount C1 according to the related art. Further, the front wheel deceleration C4 according to the present disclosure may allow the maximum deceleration to be increased and the time to reach the maximum deceleration to be shortened through the regenerative braking active control compared to a front wheel deceleration C3 according to the related art.

### Rear wheel circuit failure/rear-wheel drive or four-wheel drive

When a brake fluid leak failure occurs a rear wheel circuit of a rear-wheel drive (RWD) vehicle, the processor 100 generates the regenerative braking force for the rear wheels to perform the backup braking of the vehicle. In this case, the processor 100 generates hydraulic braking force for the front wheels and regenerative braking force for the rear wheels using the third hydraulic control valve 53 and the seventh hydraulic control valve 57.

When the brake fluid leak failure occurs in the rear wheel circuit of the four-wheel drive (4WD) vehicle, the processor 100 generates regenerative braking force for the front and rear wheels to perform the backup braking of the vehicle. The processor 100 generates hydraulic braking force for front wheels, to perform the backup braking of the vehicle using the hydraulic braking force and the regenerative braking force.

Referring to a rear wheel regenerative braking amount D2 and a corresponding deceleration D4 when the brake fluid leak failure occurs in the rear wheel circuit of the rear-wheel drive (RWD) or four-wheel drive (4WD) vehicle according to the present disclosure, the processor 100 generates a braking request signal if a user's braking intention is delivered to the brake pedal 10. Based on the generated braking request signal, the regenerative braking actuator 120 disposed on the rear wheel increases the regenerative braking force. When the regenerative braking force increases, the processor 100 generates the regenerative braking active control request signal to perform regenerative braking slip control on the rear wheel in order to prevent the rear wheel from slipping due to the generation of the excessive regenerative braking force. The regenerative braking slip control can prevent the rear wheel from slipping due to the regenerative braking by reducing the regenerative braking force by a certain amount.

The processor 100 may decrease the regenerative braking amount by a preset amount while the regenerative braking active control request signal is activated, and then increase the regenerative braking amount again.

After the regenerative braking slip control of the rear wheel, the processor 100 increases the regenerative braking force, and then decreases the regenerative braking force based on the braking request signal to control the braking of the vehicle.

The rear wheel regenerative braking amount D2 according to the present disclosure may allow the behavior of the vehicle to be stably controlled through the regenerative braking slip control, compared to a rear wheel regenerative braking amount D1 according to the related art. For example, when the regenerative braking active control request signal is activated, the rear wheel regenerative braking amount D1 according to the related art decreases by the braking force being released when the ABS request signal is activated. On the other hand, the rear wheel regenerative braking amount D2 according to the present disclosure can allow the braking stability of the vehicle to be improved because the regenerative braking force for the rear wheels is not released even when the ABS request signal is activated when the regenerative braking active control request signal is activated.

Further, the rear wheel deceleration D4 according to the present disclosure can allow the maximum deceleration to increase through the regenerative braking active control, compared to a rear wheel deceleration D3 according to the related art.

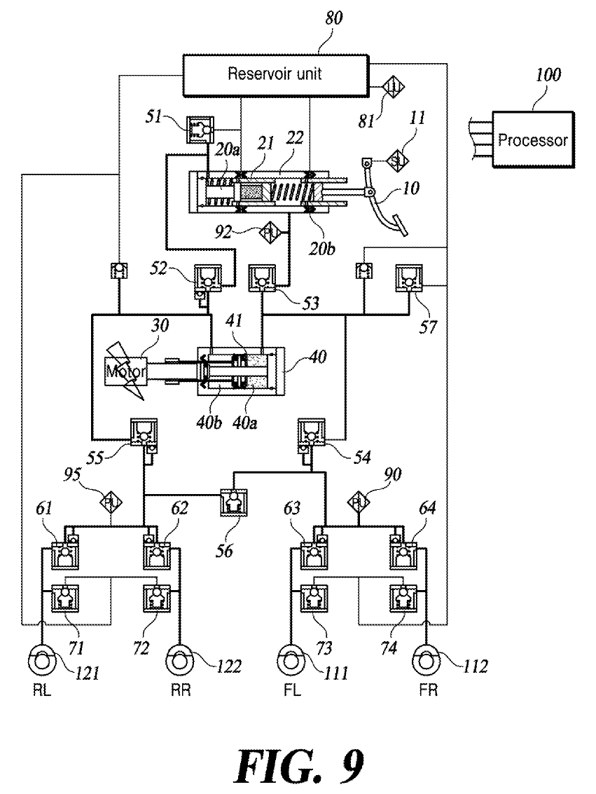

FIG. 9 is a diagram illustrating a case in which a failure occurs in the hydraulic actuator of the regenerative braking apparatus for a vehicle according to an embodiment of the present disclosure.

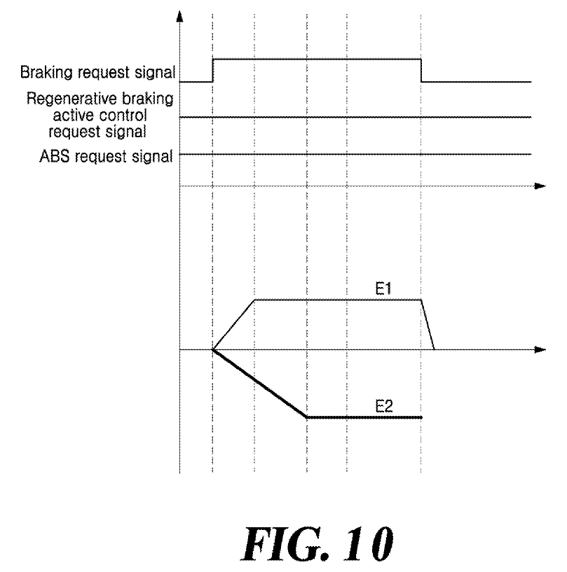

FIG. 10 is a graph showing a regenerative braking deceleration of the vehicle based on the regenerative braking of the front wheels when a hydraulic actuator fails in the front-wheel drive type vehicle according to an embodiment of the present disclosure.

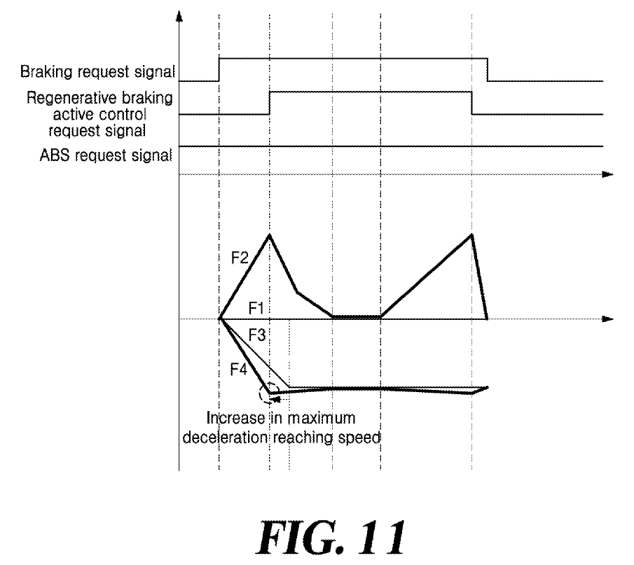

FIG. 11 is a graph showing a regenerative braking deceleration of the vehicle based on the regenerative braking of the rear wheels when a hydraulic actuator fails in the rear-wheel drive type vehicle according to an embodiment of the present disclosure.

Referring to FIGS. 1 and 9-10, when the hydraulic actuator fails, the vehicle cannot generate hydraulic braking force for the front and rear wheels. In this case, the processor 100 generates deceleration using the regenerative braking force for the front wheels and the regenerative braking force for the rear wheels. Here, the regenerative braking force may be generated based on the driving wheels of the vehicle.

### Hydraulic actuator failure/front-wheel drive

When the hydraulic actuator fails in the front-wheel drive (FWD) vehicle, the vehicle cannot generate hydraulic braking force for the front and rear wheels.

When the hydraulic actuator fails in the front-wheel drive (FWD) vehicle, the processor 100 performs the backup braking of the vehicle by using the driver's pedal force applied to the brake pedal 10 and the regenerative braking force for the front wheels.

The processor 100 according to the present disclosure performs the backup braking of the vehicle by generating the regenerative braking force for the front wheels when the hydraulic actuator fails in the front-wheel drive (FWD) vehicle.

Referring to a regenerative braking amount E1 of the front wheel and a corresponding deceleration E2 according to the present disclosure when the hydraulic actuator fails in the front-wheel drive (FWD) vehicle, the processor 100 generates a braking request signal if a user's braking intention is delivered to the brake pedal 10. Based on the generated braking request signal, the regenerative braking actuator 120 disposed in the front wheels increases the regenerative braking force. The increased regenerative braking force decreases as the brake request signal is deactivated.

### Hydraulic actuator failure/rear-wheel drive

When a hydraulic actuator failure occurs in a rear-wheel drive (RWD) vehicle, the processor 100 generates rear wheel regenerative braking force to perform the backup braking of the vehicle.

Referring to a rear wheel regenerative braking amount F2 and a corresponding deceleration F4 according to the present disclosure when the hydraulic actuator failure occurs in a rear-wheel drive (RWD) vehicle, the processor 100 generates the braking request signal if a user's braking intention is delivered to the brake pedal 10. Based on the generated braking request signal, the regenerative braking actuator 120 disposed on the rear wheel increases the regenerative braking force. When the regenerative braking force for the rear wheel increases, the processor 100 generates the regenerative braking active control request signal to perform regenerative braking slip control on the rear wheel to prevent the rear wheel from slipping due to the generation of the excessive regenerative braking force. The regenerative braking slip control can prevent the rear wheel from slipping due to the regenerative braking by reducing the regenerative braking force by a certain amount.

The processor 100 may decrease the regenerative braking amount by a preset amount while the regenerative braking active control request signal is activated, and then increase the regenerative braking amount.

The rear wheel regenerative braking amount F2 illustrated in FIG. 11 is shown as decreasing to, for example, 0 based on the regenerative braking slip control, but is not limited thereto. The rear wheel regenerative braking amount F2 may decrease based on the regenerative braking slip control, but may decrease to be a predetermined braking amount.

The processor 100 increases the regenerative braking force after the regenerative braking slip control of the rear wheel, and then decreases the regenerative braking force based on the braking request signal to control the braking of the vehicle.

The rear wheel regenerative braking amount F2 according to the present disclosure may allow the behavior of the vehicle to be stably controlled through the regenerative braking slip control, compared to a rear wheel regenerative braking amount F1 according to the related art. For example, the rear wheel regenerative braking amount F1 according to the related art is not generated when the hydraulic actuator fails, whereas the rear wheel regenerative braking amount F2 according to the present disclosure may be generated when the regenerative braking active control request signal is activated, thereby improving the braking stability of the vehicle.

Further, the rear wheel deceleration F4 according to the present disclosure may have a higher maximum deceleration reaching speed and a higher maximum deceleration through the regenerative braking active control, compared to a rear wheel deceleration F3 according to the related art.

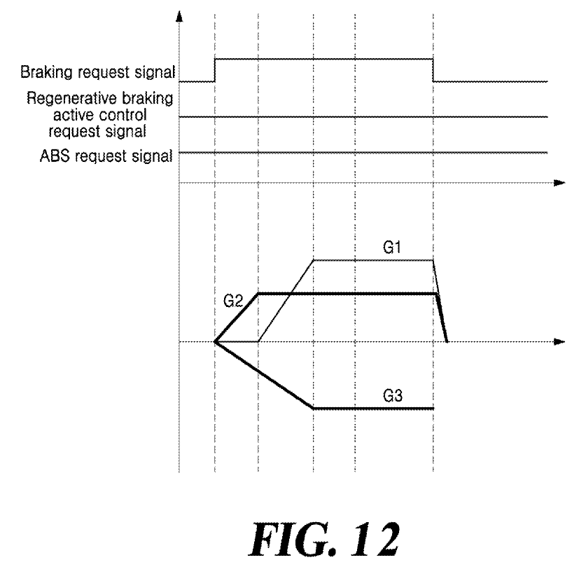

FIG. 12 is a graph showing a regenerative braking deceleration of the vehicle based on the regenerative braking of the front and rear wheels when a hydraulic actuator fails while the four-wheel drive type vehicle is driving on a high-friction road surface according to an embodiment of the present disclosure.

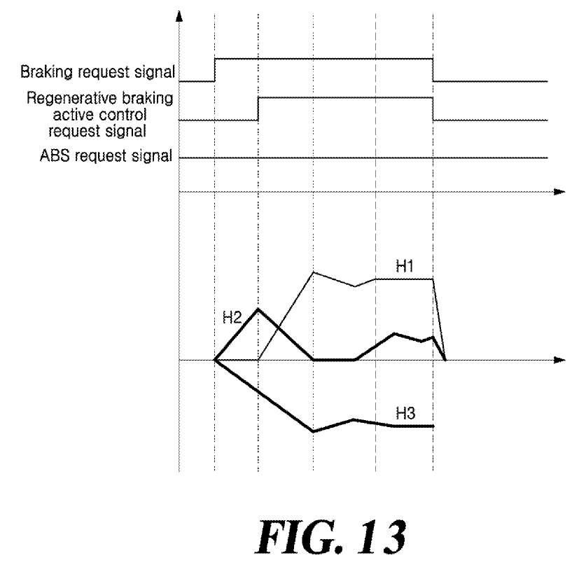

FIG. 13 is a graph showing a regenerative braking deceleration of a vehicle based on regenerative braking of the front and rear wheels when a hydraulic actuator fails while a four-wheel drive type vehicle is driving on a low-friction road surface according to an embodiment of the present disclosure.

Referring to FIGS. 1, 9, 12, and 13, when the hydraulic actuator according to the present disclosure fails, the processor 100 generates the deceleration using the regenerative braking force for the front wheels and the regenerative braking force for the rear wheels. Here, regenerative braking slip control is performed based on a friction coefficient on the road surface on which the vehicle is driving.

Referring to a front wheel regenerative braking amount G1, a rear wheel regenerative braking amount G2, and a deceleration G3 of the vehicle when the hydraulic actuator fails while the four-wheel drive type vehicle according to the present disclosure is driving on a high-friction road surface, the processor 100 generates a braking request signal if a user's braking intention is delivered to the brake pedal 10. Based on the generated braking request signal, the regenerative braking actuators 120 disposed on the front and rear wheels increase the regenerative braking force. Since the vehicle is driving on the high-friction road surface, there is no loss of driving and braking stability, such as wheel slip. Therefore, the regenerative braking active control request signal and the ABS request signal are not activated. Therefore, when the hydraulic actuator fails while the four-wheel drive type vehicle is driving on the high-friction road surface, the processor 100 implements the deceleration G3 of the vehicle based on the regenerative braking force for the front and rear wheels.

Referring to a front wheel regenerative braking amount H1, a rear wheel regenerative braking amount H2, and a deceleration H3 of the vehicle when the hydraulic actuator fails while the four-wheel drive type vehicle according to the present disclosure is driving on a low-friction road surface, the processor 100 generates the braking request signal if a user's braking intention is delivered to the brake pedal 10. Based on the generated braking request signal, the regenerative braking actuator 120 disposed on the rear wheel increases the regenerative braking force. The regenerative braking active control request signal may be activated for the vehicle driving on a low-friction road surface. Accordingly, the processor 100 increases the front wheel regenerative braking amount H1. The processor 100 decreases the rear wheel regenerative braking amount H2 as the regenerative braking active control request signal is activated, thereby preventing wheel slip from occurring due to excessive regenerative braking amount. At the same time, the processor 100 also temporarily decreases the increased front wheel regenerative braking amount H1 to prevent the vehicle driving on the low-friction road surface from experiencing wheel slip.

Therefore, when the hydraulic actuator fails while the four-wheel drive type vehicle is driving on the low-friction road surface, the processor 100 implements the deceleration H3 of the vehicle based on the regenerative braking force for the front and rear wheels.

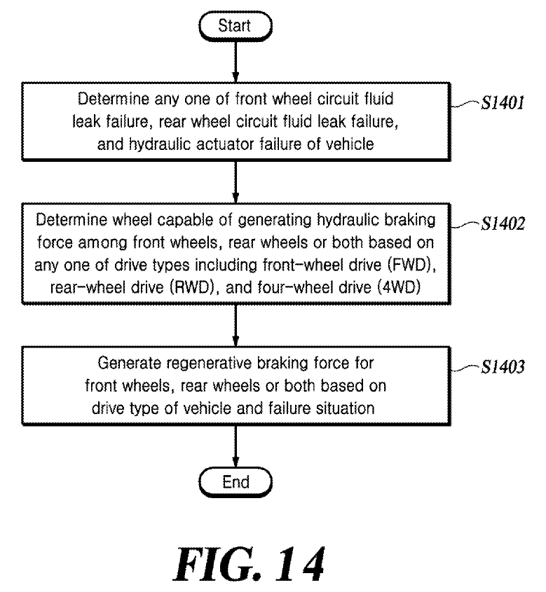

FIG. 14 is a flowchart showing a control method for regenerative braking of a vehicle according to an embodiment of the present disclosure.

Referring to FIGS. 1-14, the control method for regenerative braking of a vehicle according to the present disclosure is performed based on the regenerative braking apparatus for a vehicle configured to generate hydraulic braking force.

The processor 100 determines any one of a front wheel brake fluid leak failure, a rear wheel brake fluid leak failure, and a hydraulic actuator failure of the vehicle (S1401).

The processor 100 determines a wheel capable of generating hydraulic braking force among the front wheels, the rear wheels or both based on the driving wheels of the vehicle (S1402).

The processor 100 generates the regenerative braking force for the front wheels, the rear wheels or both based on a failure situation of the vehicle and the driving wheels (S1403).

For example, when the processor 100 determines that there is a front wheel brake fluid leak failure and determines that the vehicle is either front-wheel drive or four-wheel drive, the regenerative braking force based on the regenerative braking active control is generated for the front wheels to brake the vehicle.

For example, when the processor 100 determines that there is the front wheel brake fluid leak failure and the vehicle is rear-wheel drive, hydraulic braking force is generated for the rear wheels and regenerative braking force based on the regenerative braking active control is generated.

For example, when the processor 100 determines that there is a rear wheel brake fluid leak failure and the vehicle is either front-wheel drive or four-wheel drive, regenerative braking force based on the regenerative braking active control is generated for the rear wheels.

For example, when the processor 100 determines that there is the rear wheel brake fluid leak failure and the vehicle is front-wheel drive, hydraulic braking force is generated for the front wheels and regenerative braking force based on the regenerative braking active control is generated.

For example, when the processor 100 determines that the hydraulic actuator fails and the vehicle is front-wheel drive, the driver's pedal force applied to the brake pedal 10 and the regenerative braking force for the front wheels are used. Here, the processor 100 performs the regenerative braking slip control based on the friction coefficient on the road surface on which the vehicle is driving. The processor 100 can temporarily decrease the regenerative braking amount to prevent the vehicle from slipping.

For example, when the processor 100 determines that the hydraulic actuator fails and determines that the vehicle is rear-wheel drive, braking force is generated for the rear wheels based on the regenerative braking active control, thereby improving braking responsiveness.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A control method for regenerative braking of a vehicle configured to generate hydraulic braking force, the control method comprising:
determining any one of a front wheel brake fluid leak failure, a rear wheel brake fluid leak failure, and a hydraulic actuator failure of the vehicle;
determining one or more wheels capable of generating hydraulic braking force among front wheels, rear wheels or both based on driving wheels of the vehicle; and
generating regenerative braking force for the front wheels, the rear wheels or both based on a failure situation of the vehicle and the driving wheels.

2. The control method of claim 1, wherein the generating of the regenerative braking force for the front wheels, the rear wheels or both based on a failure situation of the vehicle and the driving wheels includes generating regenerative braking force based on regenerative braking active control for the front wheels to brake the vehicle when it is determined that a brake fluid leak failure has occurred in a front wheel circuit and the vehicle is either front-wheel drive or four-wheel drive.

3. The control method of claim 1, wherein the generating of the regenerative braking force for the front wheels, the rear wheels or both based on a failure situation of the vehicle and the driving wheels includes generating hydraulic braking force for the rear wheels and generating regenerative braking force based on regenerative braking active control to improve braking responsiveness of the rear wheels when it is determined that a brake fluid leak failure has occurred in a front wheel circuit and the vehicle is rear-wheel drive.

4. The control method of claim 1, wherein the generating of the regenerative braking force for the front wheels, the rear wheels or both based on a failure situation of the vehicle and the driving wheels includes generating regenerative braking force based on the regenerative braking active control for the rear wheels to brake the vehicle when it is determined that a brake fluid leak failure has occurred in a rear wheel circuit and the vehicle is either front-wheel drive or four-wheel drive.

5. The control method of claim 1, wherein the generating of the regenerative braking force for the front wheels, the rear wheels or both based on a failure situation of the vehicle and the driving wheels includes generating hydraulic braking force for the front wheels and generating regenerative braking force based on regenerative braking active control to improve braking responsiveness of the front wheels when it is determined that a brake fluid leak failure has occurred in a rear wheel circuit and the vehicle is front-wheel drive.

6. The control method of claim 1, wherein the generating of the regenerative braking force for the front wheels, the rear wheels or both based on a failure situation of the vehicle and the driving wheels includes performing regenerative braking slip control based on a friction coefficient of a road surface on which the vehicle is driving, by using pedal force applied to a brake pedal by a driver and the regenerative braking force for the front wheels when it is determined that the hydraulic actuator fails and the vehicle is front-wheel drive.

7. The control method of claim 6, wherein the performing of the regenerative braking slip control includes temporarily decreasing the regenerative braking amount for the front wheels and the rear wheels to prevent the vehicle from slipping.

8. The control method of claim 1, wherein the generating of the regenerative braking force for the front wheels, the rear wheels or both based on a failure situation of the vehicle and the driving wheels includes generating braking force based on regenerative braking active control for the rear wheels to improve braking responsiveness when it is determined that the hydraulic actuator fails and the vehicle is rear-wheel drive.

9. A regenerative braking apparatus for a vehicle that generates hydraulic braking force, the regenerative braking apparatus comprising:
a sensor unit configured to detect any one of a front wheel brake fluid leak failure, a rear wheel brake fluid leak failure, and a hydraulic actuator failure of the vehicle;
a processor configured to determine a failure situation of any one of the front wheel brake fluid leak failure, the rear wheel brake fluid leak failure, and the hydraulic actuator failure, and determine braking force required for the vehicle based on driving wheels of the vehicle; and
a regenerative braking actuator configured to receive a braking command from the processor and generate hydraulic braking force, regenerative braking force or both in some or all of the wheels of the vehicle.

10. The regenerative braking apparatus for a vehicle of claim 9, wherein the processor performs regenerative braking active control to prevent the vehicle from slipping by limiting a regenerative braking amount for the rear wheels based on a friction coefficient of a road surface on which the vehicle is driving.
